(19) United States
(12) Patent Application Publication
(10) Pub. No.: US 2008/0061225 A1
(43) Pub. Date: Mar. 13, 2008

(54) LOGGING TOOL FOR DETERMINATION OF FORMATION DENSITY (EMBODIMENTS)

(75) Inventors: Jacques Orban, Moscow (RU); Mikhail Iakimov, Moscow (RU)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/853,095

(22) Filed: Sep. 11, 2007

(30) Foreign Application Priority Data
Sep. 11, 2006 (RU) 2006132312

(51) Int. Cl. G01V 5/12

(52) U.S. Cl. 250/269.3

(57) ABSTRACT

An apparatus for investigating underground formations surrounding a borehole, comprises a tool body; a common gamma ray source mounted in the tool body and which, when the apparatus is positioned in a borehole, provides axi-symmetric distribution of gamma rays so as to provide substantially complete circumferential irradiation of the formation surrounding the borehole; and a detector for detecting gamma rays returning from the formation, the detector being responsive to gamma rays from only part of the borehole circumference. A method for investigating underground formations surrounding a borehole with a tool comprising a tool body having a gamma ray source and a detector mounted thereon, comprises irradiating the complete circumference of the borehole wall using a common gamma ray source which provides axi-symmetric distribution of gamma rays; and detecting gamma rays returning from the formation from only part of the borehole circumference.

### TECHNICAL FIELD

This invention relates to geophysical tools and methods used for exploration of underground formations. In particular, it relates to the domain of gamma-ray logging tools, and can be used in the density analysis and imaging of the structure of geological formations around a borehole.

### BACKGROUND ART

The images of formations surrounding boreholes are widely used in exploration and production activities in the oil and gas industry. Such images can be obtained either by means of tools which are lowered into the borehole, using a wire-line cable, or by means of logging while drilling (LWD) tools forming part of the drill string used to drill the borehole.

Borehole images obtained by using electrical measurements are widespread. A number of different logging tools are available to make such measurements, typically operating in water-based drilling muds. An example of a wireline electrical imaging tool is the FMI (Formation Micro Imager) tool of Schlumberger. The RAB (Resistivity At Bit) tool of Schlumberger gives a corresponding image in a LWD tool. There are also logging tools capable of obtaining formation images in a borehole filled with a hydrocarbon-based drilling mud, such as the OBMI (Oil Based Mud Imager) tool of Schlumberger.

Another technique used to obtain images in boreholes is based on the use of ultrasonic measurements. The UBI (Ultrasonic Borehole Imager) tool of Schlumberger is a wireline tool having a rotating ultrasonic signal source that scans around the borehole, images being constructed from the reflected signals. LWD tools also exist which make use of ultrasonic measurements. Ultrasonic measurements of this type are highly susceptible to the presence of gas in the borehole, which attenuates the signals greatly. Also, hydrocarbon-based drilling muds have a very strong absorbing ability which limits the range of standoff between the logging tool and the borehole wall to be covered by the tool.

In borehole logging, formation density is typically measured using the residual energy of back-scattered gamma rays. For this measurement, the down-hole tool is typically equipped with a Cs¹³² (and—less frequently—Co⁵⁷) radioactive source emitting high-energy gamma ray photons (with energy of 0.662 MeV for the Cs¹³⁷). The omni-directional photons emitted by the source are collimated by providing a small channel of low density material within a housing formed from a much heavier material, such that the gamma-ray photons that are not captured by the collimating material and leave the tool in a certain direction and enter in the well-bore. In conventional wireline logging, the tool section, containing the collimated gamma-ray source(s) and gamma-ray photon detector(s) of some sort, is pushed towards the borehole wall, so that the photons cross only a thin layer of mud (or even no mud at all) before entering the formation. This helps avoid (or limit) perturbation of the measurement by the mud itself.

During its propagation within a medium, the gamma ray photons interact with the electrons of the atoms forming the medium. If a photon's energy is above 0.2 MeV, Compton scattering occurs with the consequence that the scattered gamma-ray photon propagates with less energy in a potentially different direction. After multiple interactions of this type, the residual energy in the gamma-ray photon is substantially lower than at the initial state after the radio-active emission. Due to the multiple scatterings, the propagation direction is also modified, so that some of the scattered photons may propagate back towards the tool.

Within the tool, gamma-ray detectors allow to measure the energy and the number of those scattered gamma-ray photons returning to the tool. The probability of the scattering is proportional to the number of the electrons in the gamma-ray photon's path, and the number of the electrons in a given volume of the formation is proportional to the formation density. Thus, the intensity of the scattered photons' flux decreases with the increase of the density. It has been experimentally proven that for the elements with an atomic number less than 30, this intensity of the Compton photons (that is the photons with the energy of 0.2 MeV and above) is reversely proportional to the density.

After a sufficient number of the Compton scatterings, the residual energy of the propagating gamma ray photon may fall below 0.2 MeV, at which level the photon may be absorbed by one atom, while an electron of this atom is expelled: this interaction is called the photo-electric absorption. The photo-electric absorption is not strongly dependent on density and is primarily affected by the lithological properties or mineral composition of the formation.

By measuring the of the numbers of the photons entering the tool at each energy levels, the tool produces the energy histogram shown in FIG. 1.

The upper part of this histogram (from 600 to 700 keV) corresponds to detected radiation at energy levels nearly equal to the source-emitted energy. This is due to radiation propagating directly from the source to the detector (through the dense collimating material that surrounds the source) with no (or negligible) scattering effect. The importance of this part depends directly on the tool design.

For example, some tools introduce a weak non-collimated Cs¹³⁷ source(s) for in-situ electronic calibrations.

The amplitude of the middle part of the histogram (from about 200 to about 600 keV) depends directly on the density of the external medium (the formation): the higher the medium density, the lower the integral amplitude of the histogram in this region.

The ratio between the integral amplitude of the lower part of the histogram (around 100 keV) and the middle part of the histogram above allows for the estimation of the formation lithology or mineral composition as based on empirical data and numerical modeling.

In the logging application, back-scattered gamma-ray photons are commonly detected via the use of a scintillation crystal coupled with an electronic photo-multiplier.

In the borehole, the wall is typically covered by a mud cake: this layer is formed by products originally from the drilling mud. This cake is commonly thin and nearly impermeable, limiting losses of mud fluid into the formation. This mud cake often contains elements which significantly affect the absorption and the scattering of the gamma rays: barite and other salts affecting the measurements. Most logging tools are designed to compensate for the effect of the mud cake. The classic method is to include detectors at two different spacings from the source (the short and long spacing). The gamma-ray reaching a detector has to cross the mud cake twice, and propagate inside the formation depending on the geometrical spacing between the source and the detector. Therefore, the energy histogram measured at the far detector contains less energy than the equivalent histogram of the “near” detector, as the propagation path within the formation is longer but the effect of the mud cake is the same in both cases. With proper calibration, this combination of two-spacing measurements allows the effect of the mud cake to be removed or significantly reduced.

For adequate measurement, it is critical to limit the stand-off between the tool and the well-bore wall. With a wireline tool, this is achieved by mounting the radioactive source and the detectors within a pad which is pressed against the well-bore wall. The wireline tool is dragged upwards, so that the pad moved following a substantially straight line along the borehole wall. FIG. 2 shows an example of such a tool, comprising a pad 10 that is pushed against the borehole wall by a hydraulic arm 12. The pad 10 contains a nuclear source 14 and detectors 16. Pressing the pad against the borehole wall means that the measurement is affected only by the formation near that line of contact between the pad and the formation: this measurement does not cover at all the whole circumference of the well. Due to this geometrical effect, local well and formation changes or perturbations affect the density measurement.

In most designs, shields are used in the measurement pad to limit the effect of gamma-ray propagation in undesired directions. The shields are commonly heavy metal such as tungsten or even depleted uranium. A shield is typically positioned between the source and the detectors to suppress direct radiation effect. Another shield suppresses radiation due to propagation in the well-bore itself (on the back side of the pad).

Spatial measurement resolution depends on the tool design (mainly detector spacing and sensitivity, and source strength). With conventional tool design, the measurement depends on the rock within a few centimeters deep form the well-bore wall. Its vertical resolution is typically a few inches (6 inches/15 centimeters), while the circumferential coverage is also in the same range (e.g. 2 to 6 inches/5 to 15 cm).

To reach enough accuracy and reproducibility on the density measurement, it is important that the bands of the histograms contain sufficient sampling (detected gamma-rays). In a static condition, this can be achieved by ensuring a sufficient time of measurement. In logging, the tool moves continuously along the axial direction of the well. This axial velocity (logging speed) has to be limited to allow sufficient statistical sampling of the energy histogram. The conventional way to insure fair logging speed are:
use of a high activity source (may be limited by government regulation due to the risk of radiation during system handling); and
use of large detectors to increase the spatial coverage and increase the statistics (limited by tool design criteria, such as mechanical strength, borehole size, and the required vertical resolution.

With some tool designs, the logging speed may have to be limited in cases of bore-hole effect or mud cake effect. This can be the case with heavy mud, borehole in bad shape and improper pad standoff, thick and heavy mud cake, etc.

Statistical noise can also be a limitation for the design and usage of density tool. This is particularly an issue with the long spacing detectors, as the level of detected radiation is quite low.

SU 1364704 discloses a device used for determining the quality of the cementing of larger-diameter casing pipes, comprising a tool body, measuring units rotating coaxially with respect to the body, an electronics module connected to the measuring units, and a mechanism for rotating the units. The disadvantage of this device consists in low accuracy of measurements.

RU 2073896 discloses a gamma ray logging tool which is used for slant and horizontal boreholes and which includes a gamma-ray absorbing screen which is capable of rotating freely on its axis and which contains a gamma-ray source enclosed in a container and gamma-ray detectors enclosed in a hermetically sealed shell, as well as unidirectional collimation channels made in the gamma-ray absorbing screen opposite the gamma-ray source and detectors. The gamma-ray absorbing screen is made asymmetric and its center of gravity is shifted towards the collimation channels of the gamma-ray source and gamma-ray detector. The disadvantage of this device consists in low accuracy of the results obtained during the characterization of the condition of the near-wellbore formations.

RU 1653437 discloses a logging device comprising a hermetically sealed cylindrical body inside which a gamma-ray source and gamma-ray detectors are located. A gamma-ray absorbing screen is mounted on the body and contains unidirectional collimation channels for the gamma-ray source and gamma-ray detectors. In addition, the device contains a pressure system. The gamma-ray absorbing screen is mounted on the body in such a way as to allow free axial rotation of the body and of the screen with respect to each other. The pressure system is installed on the screen from the side opposite to the collimation channels of the gamma-ray source and gamma-ray detectors. The gamma-ray source and gamma-ray detectors are mounted on the cylindrical body in such a way as to allow 4π geometry.

While gamma ray measurements for density evaluation are well-known, to date, the only imaging technique has been provided in the LWD domain where the source and detector are mounted on a blade of a stabiliser and are scanned over the borehole wall as the drill string rotates. In this case, the density characteristic of a near-borehole formation can be determined. The source of gamma rays and the detectors in this tool are displaced from the center of the tool to its periphery. The density measurement is strongly focused in azimuth. When the tool rotates during the drilling process, the density measurement scans the whole circumference of the borehole. With correct synchronization of the readings with the angular coordinates, it is possible to obtain a map of formation densities measured in azimuth and in depth. This allows a borehole density image to be obtained. However, the resolution of this image is limited in space.

The limitations of LWD are well-known and the present invention seeks to provide a technique that can also be applied to the wireline logging domain so as to be available when LWD cannot be used (for example, in case boreholes, or after drilling has finished).

### DISCLOSURE OF THE INVENTION

A first aspect of this invention provides an apparatus for investigating underground formations surrounding a borehole, comprising:
a tool body;
a common gamma ray source mounted in the tool body and which, when the apparatus is positioned in a borehole, provides axi-symmetric distribution of gamma rays so as to provide substantially complete circumferential irradiation of the formation surrounding the borehole; and
a detector for detecting gamma rays returning from the formation, the detector being responsive to gamma rays from only part of the borehole circumference.

By providing a common source for full circumferential coverage, azimuthal discrimination of the density measurements is made possible.

In one embodiment, the source is mounted in the tool body such that it is located substantially at the centre of the borehole when the body positioned in the borehole.

In this case, the source is preferably located in a chamber in the tool body which is provided with a circumferential slit through which gamma rays may be emitted. The chamber is preferably evacuated. An outer wall can be provided to ensure hydraulic isolation from borehole fluids.

A different embodiment providing full circumferential coverage comprises an elongate source disposed around the circumference of the tool body. In a particularly preferred form, such a source comprises a source disposed in a tube that is located in a circumferential groove in the tool body.

In a second embodiment, the common source provides a beam of limited circumferential coverage that is scanned around the borehole wall.

It is particularly preferred that the source is mounted for rotation about the longitudinal axis of the tool body.

The rotation mounting typically comprises a housing defining a chamber in which the source is located, the housing being rotatably mounted in the tool body. The housing can be provided with shielding and slots to provide a collimated beam.

In one embodiment, the source is fixed in the housing which rotates relative to the tool body. In another, the source is fixed relative to the tool body and the housing rotates around it, the relative movement of the housing around the source causing the radiation beam to scan the surface of the borehole.

The housing can comprise walls defining extended channels projecting radially away from the source, towards the borehole wall. The channels can be regularly spaced around the source. The channels are preferably closed at their outer ends, for example by low density windows, to prevent ingress of borehole fluid when in use.

In another embodiment, the source is mounted eccentrically relative to the tool body such that it orbits the tool axis when the housing is rotated. In one case, the offset of the source from the tool axis is substantially constant. In another the offset of the housing from the borehole wall is substantially constant as the housing rotates. In one form of this, the housing is pushed against the borehole wall as it rotates about the tool axis.

Another form of rotating source comprises a number of separate collimated sources arranged around the tool axis.

As well as chemical sources of gamma radiation, sources operating by secondary emission can also be used. One example of this comprises a high energy radioactive source disposed in a chamber, the radiation from the source interacting with the wall of the chamber to create gamma radiation.

The high energy source is typically disposed at the centre of an evacuated chamber. The walls of the chamber can comprise a layered structure including a first layer of a material which interacts with the high energy radiation from the source to produce gamma rays of the required energy, a second layer made from a material that absorbs gamma rays and is provided with slits to allow gamma ray emission in predetermined directions only; and a third layer to isolate the chamber from the borehole fluids.

Electric or magnetic fields can be provided to focus the high energy radiation towards the walls of the chamber. Plate electrodes above and below the chamber are typically provided for such an electric field. Axi-symmetric ring electrodes can also be provided to further enhance the focusing effect.

Magnetic fields can be provided by generating radial electric currents in the plates. Toroidal coil electrodes can be provided for this use.

Secondary generation sources can be applied in the rotating source embodiments described above.

A rotating secondary generation source can also be provide by arranging for dynamic, non-uniform fields to be applied so as to provide a localized secondary generation point source that is scanned around the chamber as the fields change.

One way to provide the necessary dynamic field is to use a segmented electrode, the segments of which are sequentially energized to produce the rotating effect. Non-active electrodes can be energized with opposite polarity to deflect radiation in the generation direction.

Axial magnetic fields can also be applied to generate the rotating source. These axial fields can be provided by multiple coils aligned parallel to the tool axis and arranged around the periphery of the chamber. U-shaped electromagnets can be disposed around the periphery of the chamber so as to embrace the upper and lower surfaces to guide the fields in the desired directions.

It is particularly preferred to provide multiple detectors to allow compensation of borehole effects. At least one of the detectors should be close to the source so that the path from the source to the detector has a relatively small formation component.

It is also preferred to measure the standoff between the source and the formation to allow compensation for borehole effects. The standoff measurement can be an ultrasonic pulse echo measurement, an mechanical system, or a nuclear transmission measurement measuring gamma radiation flow between the source and a detector mounted at the borehole wall.

An excluder can be provided to displace borehole fluid around the source and detector and so alleviate borehole effects. The excluder can comprise a solid cylinder or ring of a material that has low gamma ray attenuation and surrounds the tool body. Alternatively, the cylinder can be hollow. The rings can be provided with channels to allow borehole fluid to flow past the exclude as the tool is moved through the borehole.

A preferred embodiment comprises several detectors mounted on a pad that can be pressed against the borehole wall when making measurements. It is particularly preferred that multiple pads are provided spaced around the tool body. Each pad can provide detectors covering a predetermined section of the borehole circumference, for example +/−20 degrees from a nominal measurement direction.

The pads can be rotatably mounted on the tool body so as to scan over the circumference of the borehole wall. In one embodiment the pad also includes the source.

Another aspect of this invention comprises a method for investigating underground formations surrounding a borehole with a tool comprising a tool body having a gamma ray source and a detector mounted thereon, the method comprising:
irradiating the complete circumference of the borehole wall using a common gamma ray source which provides axi-symmetric distribution of gamma rays; and
detecting gamma rays returning from the formation from only part of the borehole circumference.

### BRIEF DESCRIPTION OF THE DRAWINGS

FIG. 1 shows a histogram of gamma ray energy in density measurements;

FIG. 2 shows a prior art gamma ray density tool;

FIGS. 3-7 show embodiments of rotating sources for use in the present invention;

FIGS. 8-11 show embodiments of secondary emission sources for use in the present invention;

FIG. 12 shows an embodiment of the invention using an excluder; and

FIG. 13 shows an embodiment of the invention comprising pad mounted detectors.

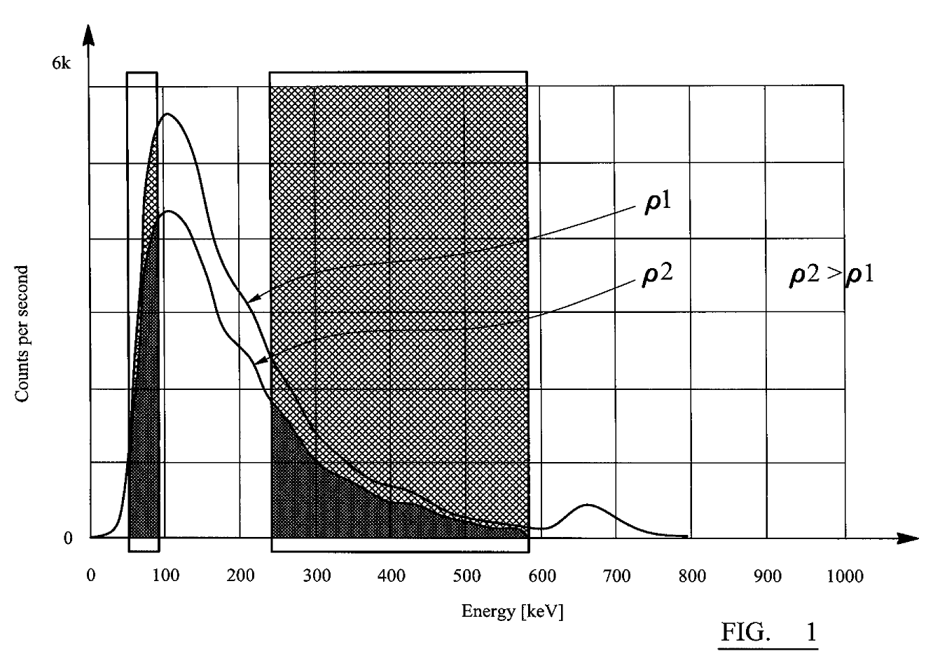

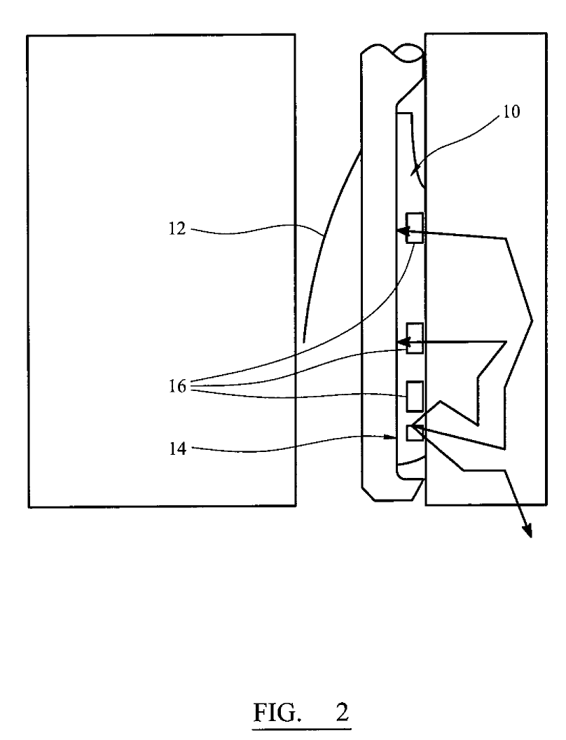

### MODE(S) FOR CARRYING OUT THE INVENTION

The present invention provides techniques for use in imaging tools. An imaging tool has to ensure a proper coverage of the well-bore with maximum uniformity. The imaging process requires the use of multiple paths (signal source, receiver) of measurements: each measurement representing one pixel of the image, as it is affected by the properties of the local material of the bore-hole.

To limit the complexity of the system, most imaging system share the source between multiple measurements. It is typical to install the common source and the arrays of receivers at a given position: then the measurements on all receivers are performed in a quasi-simultaneous fashion. This general concept also applies in the present invention. The nuclear source generates gamma rays in random time and random direction. However, if the radioactive source has a relatively high activity, it can be considered that gamma rays are transmitted in all directions with a nearly uniform probability at any time of measurement.

For proper imaging of the bore-hole, “quasi” uniform gamma ray emission around the bore-hole is required. This can be achieved either with an instantaneous emission all around the bore hole or with a rotating radial source. Different implementations can be used for this objective.

In one embodiment, the source is installed at the center of the bore-hole. A mechanical implementation ensures that the source is at the center of the wireline tool body which can itself be centralized in the bore-hole.

One example has a fixed central source. The source comprises a small radioactive element generating the gamma radiation directly. The source is located at the center of the tool, contained inside a housing defined by a chamber of heavy metal with a circumferential slit at the periphery of the wireline tool. This slit allows radiation to exit the tool in an axi-symmetrical fashion. The chamber may be under vacuum to limit the ray scattering and absorption within the chamber. A thin wall may be provided to ensure hydraulic isolation from the well bore fluid. This thin wall can be wrapped around the heavy metal with the slit.

In another example, a rotating source is used. The uniform emission versus azimuth of gamma-ray towards the formation can be achieved by rotating a focused source inside the well-bore. After one rotation at constant speed, the energy distribution is uniform for all azimuths. For high radiation energy and better use of the receivers, multiple sources installed at different azimuths of the rotating mechanism can be used.

Various designs of rotation systems are possible:

### 1) As is shown in FIG. 3, the housing 20 that includes the source 22 and its focusing shielding (not shown) rotates around its own axis while being centralized in the well 24.

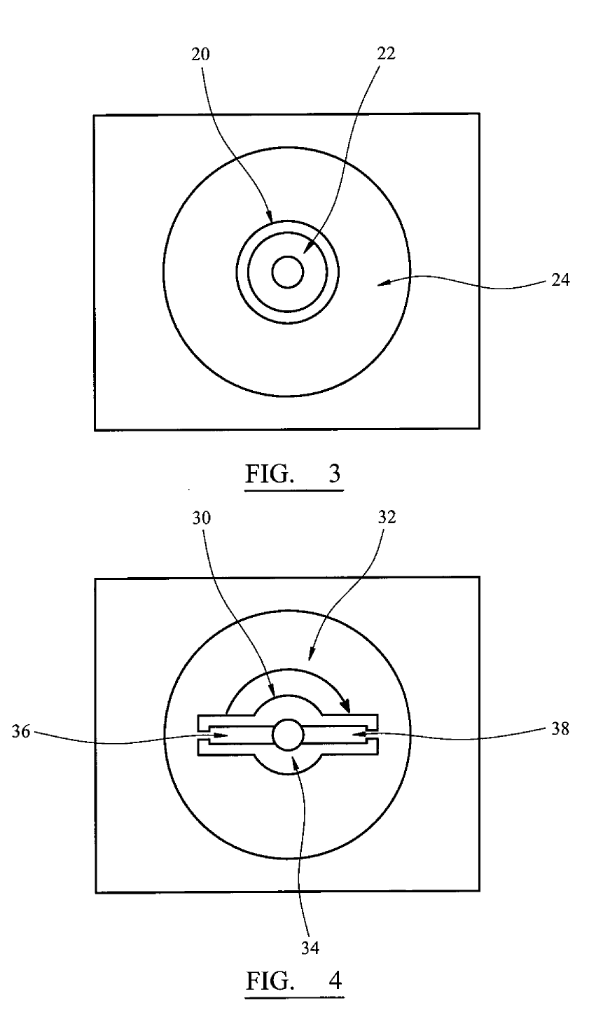

2) In the embodiment of FIG. 4, the source housing 30 (with shielding only for axial radiation) is fixed at the center of the tool which is centralized in the well bore 32. A hollow cylinder 34 with wings 36 rotates around the source housing 30. The rotating device 34 and wings 36 are mainly made of heavy materials with holes 38 for gamma-ray focusing: these holes extend into the wings 36, so that gamma-rays can propagate towards and into the formation with minimum attenuation. The shape of the wing 36 ensures that enough well section is still available for well-bore fluid re-circulation during tool displacement in the well.

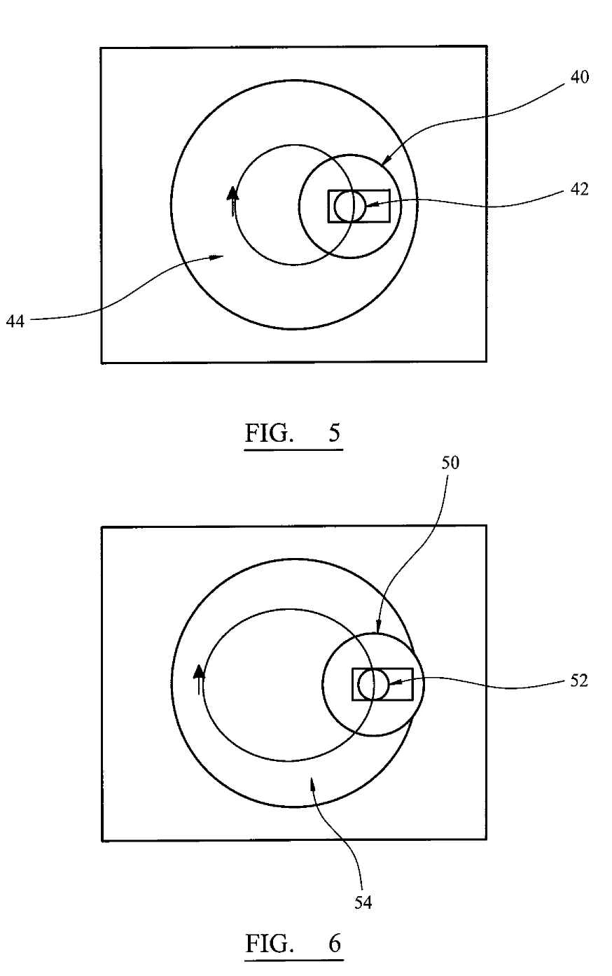

### 3) In the embodiment of FIG. 5, the housing 40 is off-center and it rotates with its center (where the source 42 is located) at a constant standoff from the rotation axis (which is normally at the center of the borehole 44).

### 4) In the embodiment of FIG. 6, the housing 50 is again off-center and it rotates with its face 52 at a small, substantially constant standoff from the formation 54. This means the rotation radius is adapted to the well bore geometry.

### 5) In one particular example of the embodiment of FIG. 6, the housing rotates with its face against the formation (i.e. zero stand-off).

The standoff from the formation is reduced from solutions 1 to 5, improving the radiation level into the formation to be characterized: with the source close to the formation, less energy spreading by spherical divergence affects the radiation before reaching the formation with less attenuation by the wellbore fluid.

The rotating focusing imposes the condition that information for imaging can only be acquired from the detectors aligned azimuthally with the source. In practical terms, this means that the logging speed should be low enough for proper coverage of the full well-bore. Data acquisition can then be synchronized to the rotation angular position. Detectors within a azimuthal angle of +/−25 degrees can typically be used for proper density imaging.

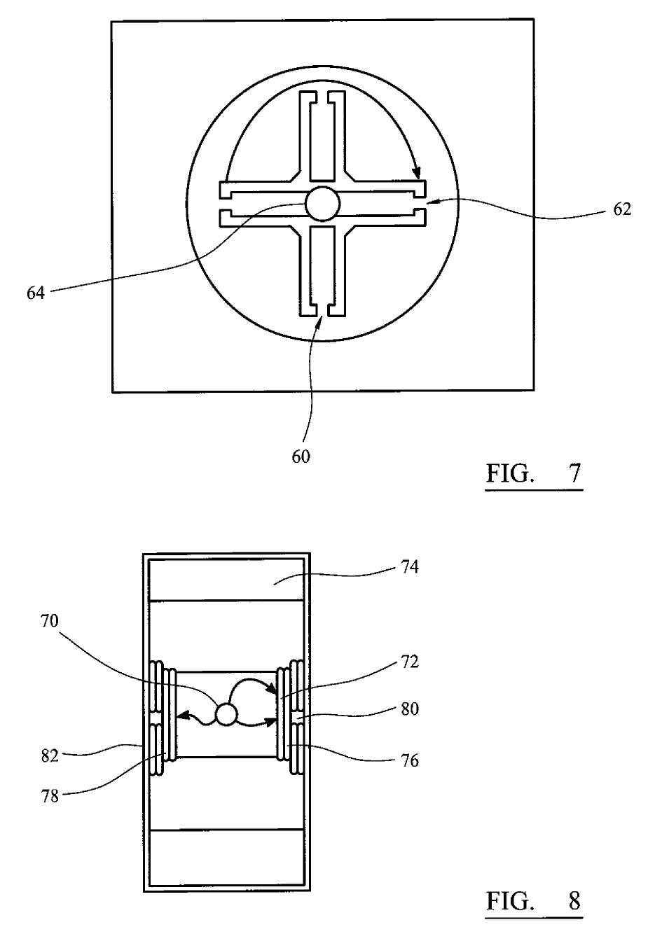

Improved usage of the detectors can be achieved with multiple rotating source points. Four source points can be installed at 90 degrees from each other. Solution 2 discussed above in relation to FIG. 4 allows another solution to obtain multiple measurement points with a single source. For this application, the shielded rotating head is equipped with multiple low-density windows so that high levels of radiation can escape from the head at various points. These windows may be at the front of wing shape mud excluders for limiting the borehole effect. FIG. 7 shows a corresponding embodiment with two pairs of mud excluders 60, 62 centered on the source 64 giving four measurement points.

It is also possible to use detectors not azimuthally aligned with the source for imaging of dipping event as will be described below.

One way to provide axi-symmetrical gamma-ray emission around the logging toot is to use a long distributed source which is wound around the tool body. One implementation of this approach uses a small diameter tubing and with proper distribution of the radioactive material inside the tubing. The tubing plays the role of protector for the radioactive element. During the source installation, the small tubing is forced into a circumferential groove in the tool: this groove is near the periphery of the tool, and is accessible via a tangential hole. This tangential hole can be used for source loading. This hole is plugged with a proper retainer, so that the source cannot be lost in the hole.

In conventional tool design, the directivity of the gamma-ray emission towards the formation is obtained by shielding the source so that the gamma-rays propagating in unwanted directions are absorbed. This technique is adequate for the ensuring the proper source directivity. However most of the emitted photons are absorbed and in the case of an imaging tool, this approach can make the design inefficient, as high energy sources or multiple sources are required.

To counteract this difficulty, a different source concept can be used so that most of the radioactive process generates gamma photons towards the formation. This increases of efficiency makes the system more adequate for imaging.

This technique is based on the following concept (see FIG. 8):
A radioactive source 70 is used which generates high energy charged particles (such as alpha or protons).
This source is installed at the center of the tool in a vacuum chamber 72. The vacuum chamber is limited by the cylindrical shape of the tool body 74 and by two plates perpendicular to the tool axis.
The circumferential wall of the chamber is made of three layers:
   The inner layer 76 is made of material which interacts with the charged particles. These particles are absorbed by nuclei of this material which stabilize themselves by some nuclear processes which release gamma rays.
   The second layer 78 is made of a heavy material and is cut by a thin circumferential slit 80. This slit allows the gamma-rays to propagate towards the outside of the tool, while the rest of this layer blocks most of the other gamma-rays.
   The outside layer 82 is a thin wall of high strength material to contain the well-bore fluid outside the chamber.
Electrical or magnetic fields are used to bend the trajectory of the high energy particles towards the circumferential wall, while avoiding absorption by the flat plates.
The gamma-rays are produced at the periphery of the tool in a quasi uniform distribution, but in random direction. The second layer of the circumferential wall ensures focusing of the gamma-rays via the slit towards the formation.

The approach offers a number of potential advantages:
Minimum loss of primary radioactive emission in the direction of the tool.
High probability for the primary radioactive emission to reach the converting layer at the periphery of the vacuum chamber.
The gamma-rays emitted at the conversion layer are focused towards the formation by conventional shielding. The photons moving towards the outside pass through the circumferential slit of the shield and continue their propagation towards the formation The photons propagating towards the inside of the vacuum chamber have a high probability of being absorbed. Compared to the conventional focusing of a normal density tool, the probability that a radioactive emission of the source generates radiation outside the tool towards the formation is nearly three times higher.
The emission outside the tool is nearly uniformly distributed.
The photon distribution through the slot can be adapted by the control of the focusing fields inside the vacuum chamber. This can be useful to obtain a rotating beam of gamma radiation around the tool, with still the high probability of success of reaching the proper direction outside the tool.

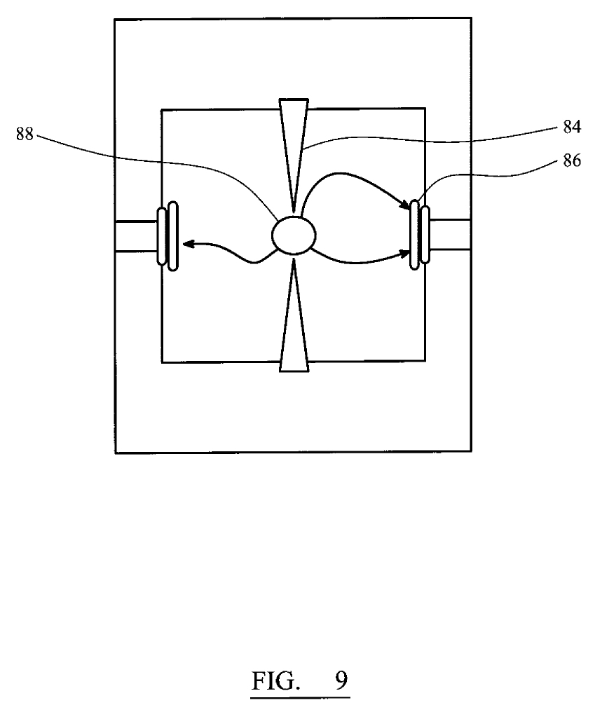

The bending of the particle path can be achieved by the use of electrostatic fields (see FIG. 9) with focusing electrodes 84, 86 positioned relative to the source 88 to influence the path of the emitted particles:
In one design, high electrical field can be applied between the nuclear source and the circumferential wall, so that the charged particles are attracted by the circumferential well (near the slit).
In another version, the guiding field can be applied between a thin wire which is following the tool axis and attached between the plates. In this case, the field lines are more effective in bending the paths of the particles leaving the source towards the plates.
Additional axi-symmetrical ring electrodes can be added at (near) the surface of the plates to influence the electrical field in the vacuum chamber for optimum particle guidance towards the circumferential target.

The bending of the path of the charged particles can also be achieved by the used of magnetic fields. The force to bend the trajectory of the particles is obtained from the vector product of magnetic field and particle velocity x charge. This means that the particle path is bent due to the acceleration perpendicular to the plane of the two other vectors (field and velocity).

In one embodiment of this invention, the magnetic flux is arranged to be perpendicular to the radial plane: it should in theory be following a circle. It could also be approximated by series of chords. Also, the flux should be directed in one direction near the bottom plate, and to the other direction near the top plate, while being null in the plane at mid distance from both plates. This means that the flux amplitude depends on the Z coordinate while increasing towards the plates but heaving the opposite rotation direction.

The radioactive source is installed at coordinates Z=0/R=0 (R, α being cylindrical coordinate in the plane perpendicular to the tool/hole axis).

With this field distribution, the following acceleration is applied to the charged particles:
When the particles move radially in the horizontal plane (Z=0), no acceleration is generated. The particles continue following the same radial path towards the slits.
When the particles are transmitted towards the plates with an angle γ from the Z axis, the particle is submitted to a radial acceleration which bends the path within the radial containing the Z axis. The angle γ increases such that the particle may finally move towards the other plate crossing the source/slit plane and finally entering in the field of reverse direction: in this situation, the particle path is bent in the other direction. This means that the particle is moving outwards towards the slits in an oscillatory path.

The amplitude of the circumferential field is optimized following a law depending on (Z,R):
For each R, the flux is maximum near the plate (Zplate) and null at Z=0.
For each R, (Z constant), the flux is mathematically optimized for minimizing the oscillation of the particle path towards the slots.
The flux distribution is symmetrical versus the plane Z=0.

The circumferential magnetic field can be generated by radial electrical current in the plates. A practical realization is based on winding of wire around a ring of non-magnetic material (toroid). The ring has sufficient thickness to ensure a relatively large distance between the two “flat” surfaces of wire.

Each radial wire generates a circular magnetic field which decays as 1/L with “L” being the distance from the considered point to the wire. Due to the combination of the multiple radial wires, the magnetic field appears to be a nearly continuous circumferential line.

With the proposed toroid wiring, the apparent radial current density reduces with R (R=distance from the tool center): So the magnetic field reduces with R.

As a toroid, perfect winding is used at each cavity plate. The combined field in the cavity meets the (approximate) requirements:

| | |
|---|---|
| For any R, | Flux = 0 for Z = 0 (within the plane of source/slit) |
| For each R, | Flux (R, Zplate) = max(R) (flat plate) |
| At Zplate, | Flux (R, Zplate) = Flux(0, Zplate)/R |
| At point (R, Z) | Flux = Flux(0, Zcavity)/R {1/(Zplate − R) − 1/(Zplate + |
| | R)}. |

If particles are not deflected enough and enter inside the ring, they are strongly influenced by the high circumferential flux and are redirected towards the central plane of the system (outside the winding). Making the winding as light as possible with minimum cross-section avoids the particles being absorbed by the winding material. The core of the winding can be a vacuum for limiting particle absorption.

More complex toroid winding can be used to impose a predetermined distribution of the radial current average density in the winding plane. This allows to control the distribution of the flux versus R. This can be useful for optimum guidance of the particles towards the circumferential target and the slit.

Ensuring that the fields from both toroid windings are properly balanced ensures the proper field distribution. In theory with perfect geometrical system and uniform material properties, the current should be equal in both windings. In practical applications, it may be necessary to adjust the current in the windings for the perfect balance.

It is important to ensure that the electrical power transmission from one side of the cavity to the other side is performed while providing perfect field cancellation of the currents (in and out). Without perfect cancellation, charged particles will be submitted to circumferential acceleration which is not optimum for the present device operation. In the ideal case, a coaxial cable could be used at the axis of the tool. However the source is also at the center of the cavity; so that other approaches may have to be used. One is to install the coaxial cable at the periphery of the chamber, supposing that it magnetic radiation is nearly null. Some slight improvement can be achieved by installing several coaxial cables at the periphery at uniform angular positions.

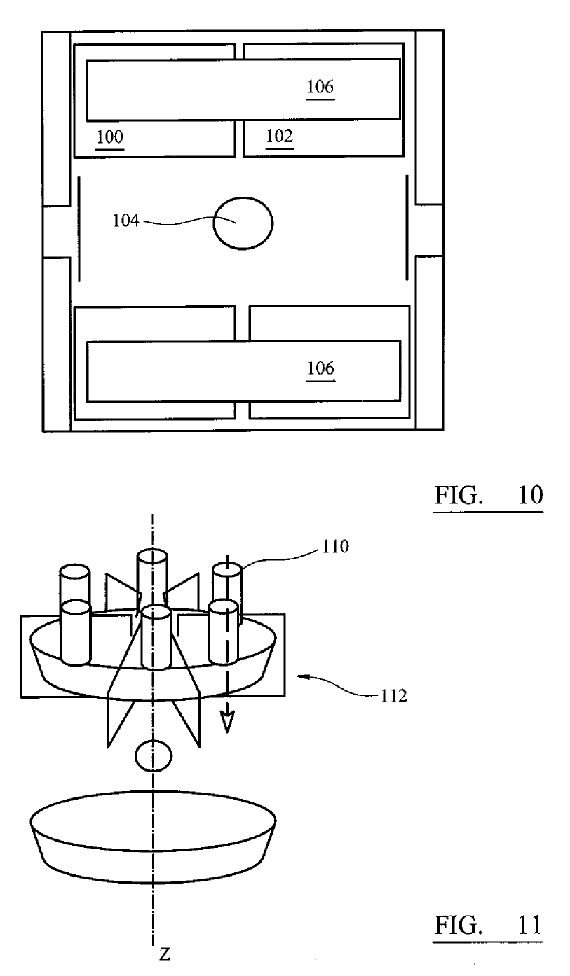

The thickness of the toroid winding should be large enough to limit the influence of the wires on the remote flat face of the ring. For large spacings, the shielding material can be contained within the toroid itself: This shield may fill only part of the toroid cross-section. FIG. 10 shows one such example with the toroid windings 100, 102 being disposed on either side of the source 104 and the shield material 106 being contained within the toroids.

By operating the system such that the guidance is not constant (and uniform) in the chamber, the high energy particle flux can be made to rotate. As a result of this rotating flux, the gamma-ray emission outside the tool can also be caused to rotate. Multi-pole energization (a quadri-pole gamma-ray emission) is preferred.

With an electrostatic guidance system, one possible implementation of a quasi rotating guidance can be obtained by splitting the electrode at the circumferential wall into multiple segments. The electrical system applies the guidance voltage only to specific segments of electrode to attract the charges particles towards them. If the electrical field is successively applied to the successive segments, a quasi rotating guidance is obtained. The un-used segments can be charged at the reversed potential to deflect any particles towards the desired direction.

With a magnetic guidance system, the rotary effect can be obtained by applying an axial magnetic field: this forces the radially moving charges to deflect their trajectory in the plane of the focalization slit. This deflection stops (or at least reduces the particles reaching the circumferential target in that zone. FIG. 11 shows an embodiment in which rotating guidance is obtained via the proper drive of multiple coils 110 installed at the periphery of the chamber (with their axes being parallel to the tool axis Z). With this system, symmetrical guidance system is preferred by using U-shape electro-magnet at top and bottom of the source chamber. It should be noted that multiple U-shape electro-magnets 112 are required to produce the rotation effect. For proper guidance of the magnetic flux through the proper magnet pole, the U-shape electro-magnets 112 are not connected at their centers.

When standoff is present between the tool and the formation, gamma-rays must pass through mud/borehole fluid before reaching the formation, leading to gamma-ray absorption inside the bore hole. This absorption is a limitation for the measurement quality, as the number of photons transmitted to the formation is drastically reduced. This absorption depends on the hole size (caliper) which may not be constant over the length of the hole, as well as on the mud properties (in particular mud density and the presence of special absorbing (high density) materials such as barite).

For proper imaging with a central radioactive source, it is desirable to either provide compensation for bore-hole effects (absorption), or to modify the tool design to limit this bore-hole effect. The best performance may be obtained by combining both approaches.

One compensation scheme is based on a direct measurement of gamma-ray attenuation across the fluid in the bore-hole. This measurement, at least one detector is placed at a fixed distance (a few centimeters) from the gamma-ray source, so that the gamma-ray path from the source to the detector is mainly through the well-bore fluid. Using this measurement allows to determine the attenuation through the mud.

Full compensation requires the determination of the length of the attenuation path in the bore-hole. If the tool is well centralized, this path may be considered to be the same for all azimuths at this depth. In this case, a single hole size measurement for each depth (single diameter caliper) may be appropriate. For better imaging performance, a measure the source standoff versus azimuth can be used. This can be a direct measurement of the attenuation path for all directions. By taking care to ensure that the standoff is detected at the proper depth, proper estimation of the gamma-ray path for imaging purpose can be obtained. This standoff (or diameter) measurement can obtained by various methods, for example:
Ultrasonic pulse-echo measurements for direct standoff measurement. This technique allow full azimuthal coverage of the borehole either with a rotating head or with arrays.
Mechanical system to measured standoff (or diameter) for a few azimuths (such as multi-arm caliper tool).
Nuclear measurement within the fluid of the bore-hole to determine the amount of radiation directly received from the main radio-active source via the bore-hole fluid at a detector which is located in a device applied against the bore-hole wall. This detector for borehole correction is mainly sensitive to the direct radiation of the source. To achieve this response directivity, the detector can be installed in block of attenuating material (such as lead): this block is equipped with a hole facing the source to act as a window for the radiation. This approach fits well with tool using pad technology for the borehole imaging detectors.

The tool design for use with a central source can be adapted to limit the attenuation effect within the borehole. One solution is to equip the tool with a mud excluder. In practical terms, this comprises a nearly cylindrical solid body around the source section of the tool to fill a substantial part of the bore-hole section with this body. This body is designed for low gamma-ray attenuation and is preferably made of light material:
One solution is to use a cylinder of “plastic” low density material.
Another solution is a hollow vessel made of light wall (which can sustain the well pressure).

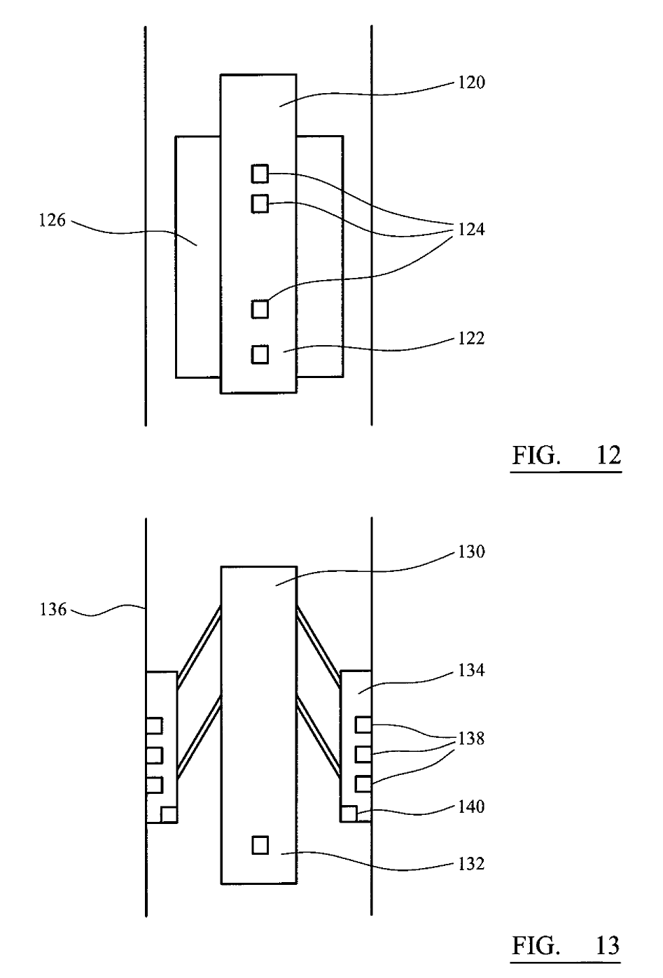

This use of a mud excluder works well with imaging tools having the imaging detectors within the main body as is shown in FIG. 12 in which the tool body 120 comprises both the source 122 and detectors 124, and is surrounded by the excluder 126 which fills most of the borehole around the tool in this region. The use of axi-symmetrical mud excluder has to be compatible with the logging speed to avoid well problems (such as swabbing):
Mud excluders of various sizes can be installed according to hole size.
Displacement speed in the well has to be chosen according to the excluder size, well bore size and mud properties (viscosity & density).
Measurements can be performed at the tool to determine swab or surge effect, for example pressure difference across the excluder and/or force on the cable can be measured at the tool.

It should be noted that the mud excluder can have a ‘crown’ cross-section so that the bore-hole fluid can flow around the excluder as well through in the inside.

In any case, excluder cannot fill the whole wellbore: it cannot replace all bore-all fluids, as the fluid has to pass from one side of the tool to the side during tool displacement in the well. Therefore, attenuation correction is still required for proper imaging. Furthermore, the use of en excluder of this type means that the source is held at some distance from the formation. This effect reduces the radiation level reaching the formation within the volume of rock which influences the measurements.

A preferred form of imaging tool is shown in FIG. 13 and comprises a tool body 130 with a central common source 132 (which can take any of the forms discussed above). Multiple sensor pads 134 are mounted on the body by means of arms that allow the pads to be pressed against the borehole wall 136. Each pad is equipped with an array of detectors 138 for imaging. The pad 134 may also have a ‘rearward facing’ sensor 140 for measuring borehole attenuation as is discussed above. Shielding (not shown) can be provided to ensure the appropriate directionality of the source and detectors and avoid influence on the detectors from the source 132. In another version of the pad tool, each pad contains its own source.

For imaging purpose, multiple detectors are typically used to speed-up the global process, while ensuring sufficient azimuthal coverage. This general also concept applies for density imaging. The bank of detectors can be installed either in the tool body itself, or in pads which are applied against the formation (see above). The detectors can be, for example:
Scintillation crystal associated with photo-multipliers.
Geiger-Muller tubes.
Other micro detectors sensitive to nuclear radiation.

Where the detectors are in the main tool body (see for example FIG. 12) multiple detectors can installed at various azimuthal positions at the same tool plane. Factors affecting azimuthal imaging resolution include:
The limited number of detectors as the tool circumference is relatively small.
The scattering in the mud of the returned photons in the mud limit the angular resolution.

Another embodiment of a tool according to the invention includes rotating detectors. This may be particularly applicable when a rotating source is used. In one example, the tool contains a section with focused source and detectors. This whole section can be rotated, so that the tool is physically facing the whole well-bore within one rotation. The imaging process of this tool is similar to the process used by LWD density tools which provide a density image.

A number of factors affect imaging resolution including the tool design and the bore-hole effect:
The azimuthal resolution of the image is limited by the scattering path of the photons in the formation: the shorter the path, the smaller azimuthal coverage. This affects vertical resolution as well as azimuthal resolution.
The mud standoff also affects the resolution (in both axes). Longitudinal wings of heavy metal can be used outside the tool in the zone of the source and the detector bank to divide the mud annulus into multiple segments. The wings prohibit the photons from being scattered from one segment to another: this improves the azimuthal resolution. These wings should ideally be mobile to extend from the tool nearly to the formation.
The imaging signal can be transformed in the spatial domain (K-domain as with seismic processing). In first approximation, the spatial density variation detected by the tool cannot be smaller than twice the detector size in that axis. This criteria imposes that the detector should be as small as possible. However, photon scattering during their travel is a limit to this criteria. Detector sensitivity defines the minimum size of detector to allow detection of signal above noise, while ensuring enough measurement accuracy.
The imaging resolution is a compromise with source strength, spacing, mud offset, and detector size.

Detector performances differ from detectors to detectors. The performances depend also on various external parameters varying with age and temperature. It is then critical to have a method to normalize these effects.

In conventional density tool using scintillation crystal and photo-multiplier, gain adjustment is performed by using direct emission of photons into the crystal from a stable micro source. Typically this micro source is installed directly in the vicinity of the crystal so that direct radiation affects the crystal with minimum scattering effect. This amplitude of the energy ray (which is the source energy level) in the energy spectrum allows adjustment the gain of the measurement chain: typically, the adjustment is performed by automatic adjustment of the high voltage of the photo-multiplier. A similar concept can be used in the imaging tool according to the invention. However, with one stabilization source per detector the total radiation energy will be high and this may become as source of noise for the imaging system.

Suitable gain stabilization for the imaging system according to the invention can be based on one of the following concepts:
With the detectors in the tool body, a micro source can be installed at the center of the tool in front of the detector. The detected signals (direct radiation form this stabilization source) by all detectors will be normalized at a unique reference amplitude, by adjusting the measurement system gain: this can be the high voltage applied to the detectors, but it can also be the gain of the amplifier in the chain before the measurement.
With the detector installed in a pad, one stabilization source per pad can be used. In this case, the direct signal measurement for each detector depends on the detector position versus the source. The measured amplitudes will be corrected according to the position (as it should be constant). Numerical modeling may be used to predetermine these geometrical coefficients. These geometrical coefficients can also be determined by calibration in a uniform density medium. An example of the basic calibration procedure can be the following:
   The gains of all measurement chains are set at the same value.
   Each detector output is recorded.
   The average value of density is calculated for all detector outputs.
   For each detector, the ratio between the average measurement and its actual measurement is calculated. This is the geometrical coefficient for the gain stabilization process.

In density logging, it is common to use two detector spacings to allow the cancellation of the mud cake. This is typically done by processing called “spine & ribs” using the density measured by the short spacing detector, as well as the difference of density between both detectors.

This can also apply for imaging purposes. One particular issue with the imaging process is the typical low gamma-ray count reaching the far detectors (as the imaging requires most of the coverage of the well-bore). Proper care needs to be applied for the far spacing detector processing. Multiple approaches are possible:
Average the output of the long spacing detectors and use this average for all azimuths.
Use of the type of detector output variation with azimuth for the short spacing detector. Apply this type of variation onto the outputs of the long spacing, using best fitting technique.
With rotary source, ensure that more time is spent on one azimuth to reduce the statistical noise for that particular azimuth: this allows the optimum determination of far spacing value for proper computation.
Limit the logging speed in heavy formation.
Combine the measurement of a conventional density tool with the imaging tool. For this application the azimuth for both logs is determined versus depth, so that the conventional density log can be considered as one azimuth “line” of the bore-hole. The density obtained with this tool is compared with the density of the imaging tool for the same azimuth at the same depth.

The imaging tool can deliver a log of formation density versus depth (average density). For this purpose, some azimuthal averaging is required. Since measurement corrections for standoff and mud cake are not linear. So for optimum accuracy, processing in accordance with the invention processes the density information for each azimuth first (to included all corrections). Then, the averaging of the azimuthal density is performed.

A simple solution to produce the image of formation density is to compute the variation of density from the near detector. This variation is the added with the average density.

Tools equipped with rotary source (either by mechanical rotation or field guidance with secondary emission), and equipped of detector bank permanently in acquisition may require a particular approach. For a conventional process of density measurement, the acquisition at the detectors should be synchronized with the emission: the detector and the source should be on the generatrix line of the hole. With a single point of emission, this makes detectors utilization low, as most of the time most detectors will be in an inappropriate position for acquisition. The utilization of the detectors can be improved by using rotating source with multiple emission points. It should be noted that four emission points at 90 degrees is particularly preferred. However, detectors on an azimuth between two source points may be affected by two nearest sources, making their direct use difficult for imaging.

For detectors of limited azimuthal offset from the source (and with source spacing large enough), the imaging path is inclined relative to the well-bore axis. This inclination can be beneficial for imaging dipping events:
If the ray is parallel to the dipping thin bed, the thin bed will have significant interaction with the gamma-ray propagation.
If the propagation path is perpendicular to the dipping events, it will have minimum impact.
The combination of the imaging process for three different angles of irradiation can benefit the imaging process which should ensure spatial consistency.

This type of irradiation allows visualization of the same volume of formation several times (at least three times). This is similar to the acquisition process of modern surface seismic with multiple coverage (multiple offsets with 2D seismic). Specific seismic-type processing can then be used to reduce the image noise and even improve its resolution.

The noise from the imaging process could be directly be achieved by averaging the density for the same mid point.

The imaging tool can be equipped with detectors at multiple spacings. These detectors can typically be on the same azimuth in the pad, but at different distances (spacing) from the source. As discussed above, most conventional logging tools are equipped with two detectors at two different spacings. The tool according to the invention can have more than two detectors, allowing more measurements for each position of the tool in the well-bore. As the spacing is different for each of them, the measurement is affected by different parts of the formation: typically, the longer the spacing, the deeper is the measurement. The depth of a measurement is typically defined by the zone which influences by 50% the response of the detectors. Appropriate processing allows separation of the effect for each depth of formation.

The use of small detectors allows the combination of two techniques of imaging by having multiple rows of detectors covering both axial extent of the tool or pad and substantially all azimuths of the bore hole: this allows for provision of images for all well-bore azimuths as well as multiple depths of measurement inside the formation.

Density imaging is obtained via a complex back-scattering process. The photons reach the detectors via complex paths. Use of the concept of migration (such as used in seismic processing) allows the origin of all scattered energy to be accurately located. The purpose of this process is improved the resolution following depth and azimuth. The correlation process includes the effect of scattering as well as absorption to allow location of the dense material. The migration process can be performed either for azimuth only or for azimuth and depth.

Another technique to improve the resolution of the image is to verify geometrical consistency between all the measurements performed at the same location. This applies particularly well with tool equipped with a rotary head, so that each element is measured three times (axial and two opposed dipping propagations) for determination of the mud cake effect. The mud cake should have the same properties (attenuation effect or thickness) independently from the propagation direction. Again this type of processing is similar to processing applied in surface seismic, especially involving a point sensor/source concept.

Forward modeling of the formation can be done to verify if the measurement and its estimated image are correct. Various elements for modeling can be considered, including:
sharp formation transition (no dip)
sharp formation transition at dip
dipping fracture
local inclusion, etc.

The purpose of the modeling is close the loop for measurement to image, as well as from formation proposition to model tool measurement and can improve the quality of the image.

The present invention finds particular use in cased-hole applications. One such application is density imaging of the annulus behind the casing. This can be used to evaluate cement quality issues, including:
Density of foamed cement after placement.
Presence of low density channel (mud or gas).
Inclusion due to gas channeling during cement setting.

This technique is complementary to acoustic imaging techniques:
It is not “too” sensitive to presence of gas in the well-bore fluid: Correction can be applied while gas in mud is a strong limitation for an acoustic tool.
It can operate in heavy mud.
It is strongly sensitive to mud channels as opposed to the case of pulse-echo high frequency system which is sensitive to micro-annulus.
It is not influenced by the surface quality of the casing.

An output of this technique can be to provide the proper correction for the log of “density behind casing”.

Another eased hole application is gravel pack evaluation. It is typically difficult to determine the proper placement of gravel in the annulus during screen packing. The density image provided by this invention can directly image it in the same way than the cement behind the casing. The metal correction has to be average out based on the type of cut and shape of screen.

A further application is the evaluation of the state of tubulars in the well, including assessing the presence of scale (type and quantity) in the production tubing and local damage to the tubing such as loss of thickness due to erosion or corrosion, cracks.

The invention also allows for inspection of a second tubing layer, for example the casing behind the tubing, or a larger string of casing hidden behind a smaller casing. For this application, the correction for the measurements should be similar to the correction for LWD density:
The first casing corresponds to the LWD collar
The annulus fluid corresponds to the well-bore fluid of the LWD application.
The second casing is the medium to provide the image.

Other uses are also possible. The particular benefit provided by this invention is that it is capable of providing density data that can be represented as a two-dimensional image in a similar way to electrical or acoustic measurement leading to improved capability in evaluation.

1. An apparatus for investigating underground formations surrounding a borehole, comprising:
a tool body;
a common gamma ray source mounted in the tool body and which, when the apparatus is positioned in a borehole, provides axi-symmetric distribution of gamma rays so as to provide substantially complete circumferential irradiation of the formation surrounding the borehole; and
a detector for detecting gamma rays returning from the formation, the detector being responsive to gamma rays from only part of the borehole circumference.

2. Apparatus as claimed in claim 1, wherein the source is mounted in the tool body such that it is located substantially at the centre of the borehole when the body positioned in the borehole.

3. Apparatus as claimed in claim 2, wherein the source is located in a chamber in the tool body which is provided with a circumferential slit through which gamma rays may be emitted.

4. Apparatus as claimed in claim 3, wherein the chamber is evacuated.

5. Apparatus as claimed in claim 3, wherein an outer is provided to ensure hydraulic isolation from borehole fluids.

6. Apparatus as claimed in claim 1, comprising an elongate source disposed around the circumference of the tool body.

7. Apparatus as claimed in claim 6, wherein the source comprises a source disposed in a tube that is located in a circumferential groove in the tool body.

8. Apparatus as claimed in claim 1, wherein the common source provides a beam of limited circumferential coverage that is scanned around the borehole wall.

9. Apparatus as claimed in claim 8, wherein the source is mounted for rotation about the longitudinal axis of the tool body.

10. Apparatus as claimed in claim 9, wherein the rotation mounting comprises a housing defining a chamber in which the source is located, the housing being rotatably mounted in the tool body.

11. Apparatus as claimed in claim 10, wherein the housing is provided with shielding and slots to provide a collimated beam.

12. Apparatus as claimed in claim 10, wherein the source is fixed in the housing which rotates relative to the tool body.

13. Apparatus as claimed in claim 10, wherein the source is fixed relative to the tool body and the housing rotates around it, the relative movement of the housing around the source causing the radiation beam to scan the surface of the borehole.

14. Apparatus as claimed in claim 10, wherein the housing comprises walls defining extended channels projecting radially away from the source, towards the borehole wall.

15. Apparatus as claimed in claim 14, wherein the channels are regularly spaced around the source.

16. Apparatus as claimed in claim 14, wherein the channels are closed at their outer ends to prevent ingress of borehole fluid when in use.

17. Apparatus as claimed in claim 16, wherein the channels are closed by low density windows.

18. Apparatus as claimed in claim 10, wherein the source is mounted eccentrically relative to the tool body such that it orbits the tool axis when the housing is rotated.

19. Apparatus as claimed in claim 18, wherein the offset of the source from the tool axis is substantially constant.

20. Apparatus as claimed in claim 18, wherein the offset of the housing from the borehole wall is substantially constant as the housing rotates.

21. Apparatus as claimed in claim 21, wherein the housing is pushed against the borehole wall as it rotates about the tool axis.

22. Apparatus as claimed in claim 9, comprising a number of separate collimated sources arranged around the tool axis.

23. Apparatus as claimed in claim 1. wherein the source of gamma radiation comprises a source operating by secondary emission

24. Apparatus as claimed in claim 23, wherein the source comprises a high energy radioactive source disposed in a chamber, the radiation from the source interacting with the wall of the chamber to create gamma radiation.

25. Apparatus as claimed in claim 24, wherein the high energy source is disposed at the centre of an evacuated chamber.

26. Apparatus as claimed in claim 25, wherein the walls of the chamber comprise a layered structure including a first layer of a material which interacts with the high energy radiation from the source to produce gamma rays of the required energy, a second layer made from a material that absorbs gamma rays and is provided with slits to allow gamma ray emission in predetermined directions only; and a third layer to isolate the chamber from the borehole fluids.

27. Apparatus as claimed in claim 25, wherein electric fields are be provided to focus the high energy radiation towards the walls of the chamber.

28. Apparatus as claimed in claim 25, wherein magnetic fields are be provided to focus the high energy radiation towards the walls of the chamber.

29. Apparatus as claimed in claim 25, further comprising plate electrodes above and below the chamber.

30. Apparatus as claimed in claim 29, further comprising axi-symmetric ring electrodes to further enhance the focusing effect.

31. Apparatus as claimed in claim 29, wherein the magnetic fields are provided by generating radial electric currents in the plates.

32. Apparatus as claimed in claim 31, comprising toroidal coil electrodes for generating the radial currents.

33. Apparatus as claimed in claim 25, wherein dynamic, non-uniform fields are applied so as to provide a localized secondary generation point source that is scanned around the chamber as the fields change.

34. Apparatus as claimed in claim 33, further comprising a segmented electrode, the segments of which are sequentially energized to produce the rotating effect.

35. Apparatus as claimed in claim 34, wherein non-active electrodes are energized with opposite polarity to deflect radiation in the generation direction.

36. Apparatus as claimed in claim 33, wherein axial magnetic fields are applied to generate the rotating source.

37. Apparatus as claimed in claim 36, wherein the axial fields are provided by multiple coils aligned parallel to the tool axis and arranged around the periphery of the chamber.

38. Apparatus as claimed in claim 37, further comprising U-shaped electromagnets disposed around the periphery of the chamber so as to embrace the upper and lower surfaces to guide the fields in the desired directions.

39. Apparatus as claimed in claim 1, comprising multiple detectors to allow compensation of borehole effects.

40. Apparatus as claimed in claim 39, wherein at least one of the detectors is close to the source so that the path from the source to the detector has a relatively small formation component.

41. Apparatus as claimed in claim 1, further comprising means to measure the standoff between the source and the formation to allow compensation for borehole effects.

42. Apparatus as claimed in claim 41, wherein the means to measure standoff comprises an ultrasonic pulse echo measurement.

43. Apparatus as claimed in claim 41, wherein the means to measure standoff comprises an mechanical system.

44. Apparatus as claimed in claim 41, wherein the means to measure standoff comprises a nuclear transmission measurement measuring gamma radiation flow between the source and a detector mounted at the borehole wall.

45. Apparatus as claimed in claim 1, further comprising an excluder to displace borehole fluid around the source and detector and so alleviate borehole effects.

46. Apparatus as claimed in claim 45, wherein the excluder comprises a solid cylinder of a material that has low gamma ray attenuation and surrounds the tool body.

47. Apparatus as claimed in claim 45, wherein the excluder comprises a hollow cylinder.

48. Apparatus as claimed in claim 45, wherein the excluder provided with channels to allow borehole fluid to flow past the exclude as the tool is moved through the borehole.

49. Apparatus as claimed in claim 1, comprising several detectors mounted on a pad that can be pressed against the borehole wall when making measurements.

50. Apparatus as claimed in claim 49, comprising multiple pads spaced around the tool body.

51. Apparatus as claimed in claim 50, wherein each pad provides detectors covering a predetermined section of the borehole circumference.

52. Apparatus as claimed in claim 50 wherein the pads are rotatably mounted on the tool body so as to scan over the circumference of the borehole wall.

53. Apparatus as claimed in claim 49, wherein the pad also includes the source.

54. A method for investigating underground formations surrounding a borehole with a tool comprising a tool body having a gamma ray source and a detector mounted thereon, the method comprising:
irradiating the complete circumference of the borehole wall using a common gamma ray source which provides axi-symmetric distribution of gamma rays; and
detecting gamma rays returning from the formation from only part of the borehole circumference.

55. A method as claimed in claim 54, comprising using the detected gamma rays to determine the density of the formation surrounding the borehole.

56. A method as claimed in claim 55, further comprising generating an image of the density of the formation.
